(19) United States
(12) Patent Application Publication
(10) Pub. No.: US 2026/0219837 A1
(43) Pub. Date: Jul. 30, 2026

(54) BUILDING TARGET DFA GRAPHS UTILIZING PREDICATES WITH INTEGER AND/OR FLOATING-POINT CONDITIONS

(71) Applicant: Microsoft Technology Licensing, LLC, Redmond, WA (US)

(72) Inventors: Edward WIMMERS, San Jose, CA (US); Eric SWARTZENDRUBER, Austin, TX (US); Ashwin Srinath SUBRAMANIAN, San Jose, CA (US); Renat IDRISOV, Menlo Park, CA (US); Vassili BYKOV, San Jose, CA (US)

(73) Assignee: Microsoft Technology Licensing, LLC, Redmond, WA (US)

(21) Appl. No.: 19/041,736

(22) Filed: Jan. 30, 2025

(51) Int. Cl. G06F 7/485

(52) U.S. Cl. CPC G06F 7/485

(57) ABSTRACT

One example provides a computing device comprising a regular expression (regex) hardware accelerator including a deterministic finite automaton (DFA) engine configured to execute an object file, and a compiler. The compiler is executable to generate the object file based at least upon a target DFA graph by receiving a predicate including one or more of an integer condition or a floating-point condition, transforming the predicate to form a rewritten predicate with an equivalent expression, and building the target DFA graph based at least upon the rewritten predicate.

### BACKGROUND

Some analytics databases and applications are designed and targeted towards handling large amounts of and/or complex data. For example, online analytical processing (OLAP) is designed for performing high-speed complex queries and multidimensional analysis on large volumes of data. Such analytical processing can be used for data warehousing, forecasting, marketing, banking, enterprise resource planning, and other suitable analysis.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

One example provides a computing device comprising a regular expression (regex) hardware accelerator including a deterministic finite automaton (DFA) engine configured to execute an object file, and a compiler. The compiler is executable to generate the object file based at least upon a target DFA graph by receiving a predicate including one or more of an integer condition or a floating-point condition, transforming the predicate to form a rewritten predicate with an equivalent expression, and building the target DFA graph based at least upon the rewritten predicate.

### BRIEF DESCRIPTION OF THE DRAWINGS

FIG. 1 shows a block diagram of an example computing system for queries utilizing numerical conditions.

FIG. 2 illustrates a flowchart of an example method for generating a target DFA graph from an integer condition.

FIGS. 3A and 3B schematically depict an example predicate and corresponding rewritten predicate, respectively.

FIGS. 4A, 4B, 4C, and 4D schematically depict an example series of DFA graphs associated with the rewritten predicate of FIG. 3B.

FIG. 5 illustrates a flowchart of an example method for generating a target DFA graph from a floating-point condition.

FIGS. 6A and 6B schematically depict an example predicate and corresponding DFA graph, respectively, utilizing a floating-point condition and an equality operator.

FIGS. 7A, 7B, 8A, and 8B, schematically depict various example floating-point conditions and corresponding DFA graphs utilizing a less-than operator.

FIG. 9 illustrates a flowchart of an example method for generating object files executable by a DFA engine for predicates including numerical conditions.

FIG. 10 shows a block diagram of an example computing system.

### DETAILED DESCRIPTION

As mentioned above, some analytics databases and applications perform queries on large volumes of stored data. Such a query is compiled and executed to produce relevant results. During query processing, a filtering phase is performed to help evaluate the large volumes of stored data and reduce a data scope for later stages of the query processing.

Current query processing may evaluate input strings for pattern matching based upon a predicate. Such pattern matching may be performed on payloads of the stored data by a hardware accelerator. This can help to perform the pattern matching of strings faster than using a general-purpose central processing unit (CPU). For example, a regular expression (regex) hardware accelerator may be configured to search an input payload for pattern matching to a regular expression specified in the predicate. Such a regex hardware accelerator may include deterministic finite automaton (DFA) engines to evaluate the regular expression. Such a DFA engine is configured to execute an object file that encodes rules for processing the input payload in terms of finite state machine graphs, or DFA graphs. Additionally, these DFA engines may offer relatively faster searches for pattern matching compared to non-deterministic finite automaton (NFA) engines.

However, current compilers may encode rules for pattern matching with a numerical condition in a DFA graph having a larger file size than an NFA graph. Such a larger file size may not leverage the relative faster searches of a DFA engine.

Accordingly, examples are disclosed that relate to building a target deterministic finite automaton (DFA) graph for a predicate including a numerical condition. For example, the numerical condition can include a comparison relative to a constant number, such as from queries for employees with an age under 42 or a salary greater than 250.50, for example. A computing device includes a compiler for generating an object file based at least upon the target DFA graph. The target DFA graph includes a single DFA graph with at least one range slot in which a range of values for an input byte uses a single transition within the DFA graph. Such a range slot helps to relatively reduce a file size of the target DFA graph and corresponding object file.

Briefly, the compiler is configured to generate the object file by transforming the predicate to form a rewritten predicate, and building the target DFA graph based at least upon the rewritten predicate. Additionally, the object file is executable by a DFA engine on a regular expression (regex) hardware accelerator to thereby determine whether a payload satisfies the numerical condition of the predicate. Such a configuration helps to reduce an overall query processing time compared to filtering payloads for the numerical condition using a CPU.

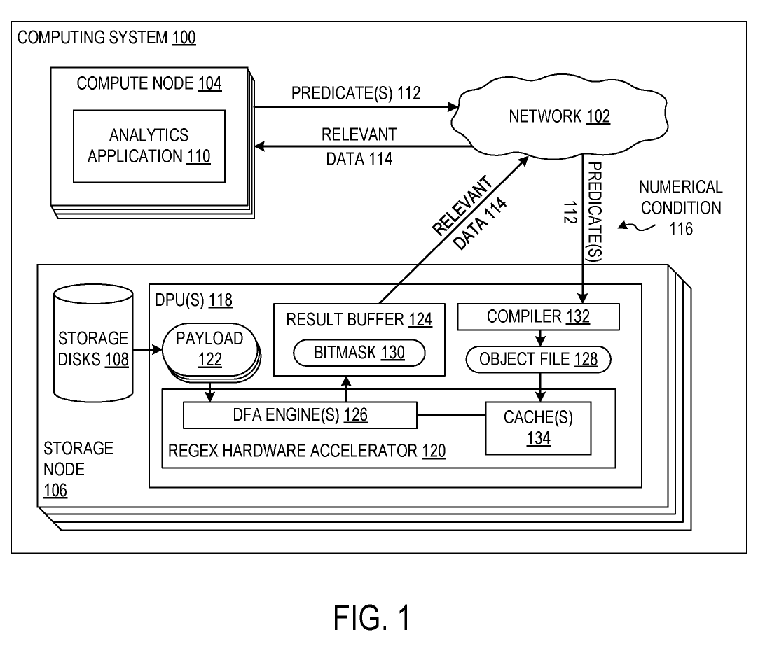

Before discussing the disclosed examples in detail, FIG. 1 shows a block diagram of an example computing system 100 for querying large volumes of data. In various examples, the computing system 100 can be in the form of a data center, a cloud computing environment, or another suitable computing system. Here, the computing system 100 comprises a network 102 interconnecting a plurality of compute nodes 104 and a plurality of storage nodes 106. Further, each storage node 106 includes one or more storage disks 108 that store the large volumes of data. The storage disks 108 can include suitable high capacity and resilient storage solutions or another suitable storage subsystem.

In the depicted example, each compute node 104 is configured to execute an analytics application 110 that processes queries on the data in the storage disks 108. For example, a user may define a set of queries to help gain insights on selected data. In some examples, a query can be expressed using structured query language (SQL) including suitable extensions and implementations thereof. In other examples, a query may be expressed in another suitable manner. While discussed here with reference to analytics applications, other suitable applications that query data may also be used.

During querying processing, the analytics application 110 sends one or more predicates 112 to relevant storage nodes 106 for filtering. Specifically, the predicate 112 is pushed to the storage node 106 for the storage node 106 to filter and aggregate relevant data 114 from the storage disks 108. Here, the relevant data 114 includes data that satisfies a numerical condition 116 of the predicate 112. Such a configuration is referred to as predicate pushdown and can help to avoid sending non-relevant data across the network 102 to the compute nodes 104. Further, this may help to relatively increase performance and/or efficiency of the query processing compared to query processing that does not utilize predicate pushdown.

As depicted, each storage node 106 includes one or more data processing units (DPUs) 118 connected to the storage disks 108. Each DPU 118 can be in the form of a microprocessor configured to run data centric computations faster than a central processing unit (CPU). Here, the DPU 118 comprises a regular expression (regex) hardware accelerator 120 configured to process a plurality of payloads 122 from the storage disks 108 utilizing the predicate 112. Additionally, the payloads 122 that satisfy the numerical condition 116 are reported in a result buffer 124. In some examples, the DPU 118 can send the contents of the result buffer 124 as the relevant data 114. In other examples, the DPU 118 can further process the contents of the result buffer 124 before sending as the relevant data 114 to the compute node 104.

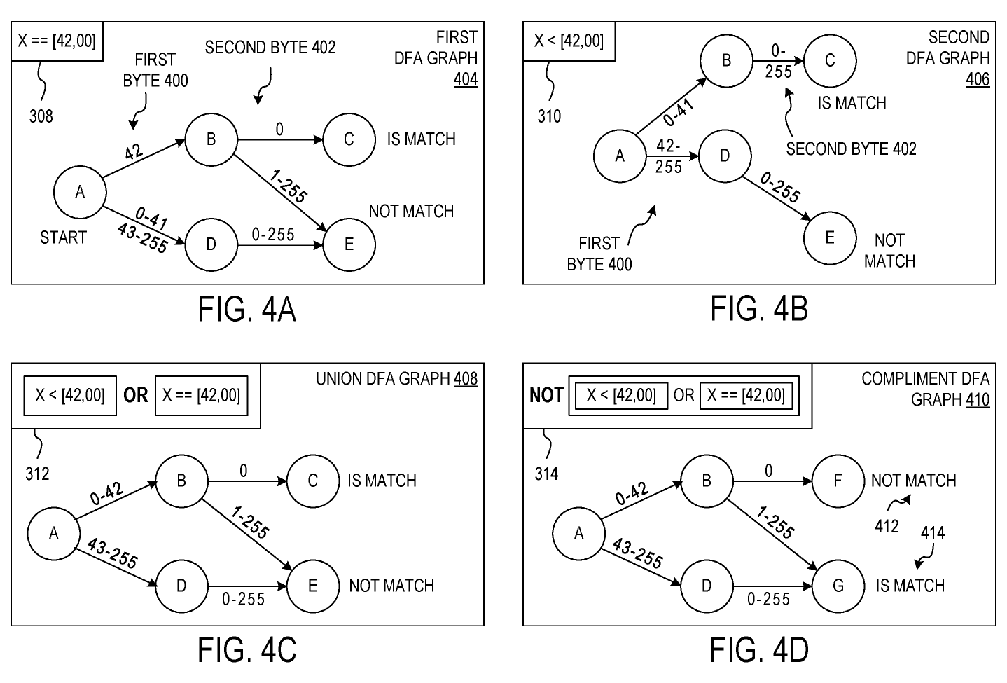

The regex hardware accelerator 120 comprises one or more deterministic finite automaton (DFA) engines 126. Here, each DFA engine 126 is configured to execute an object file 128 to determine whether a selected payload 122 satisfies the numerical condition 116. The DFA engines 126 may process the payloads 122 faster, for example using fewer compute cycles, than NFA engines. The object file 128 includes instruction code for processing the payload 122 in terms of a target DFA graph. As will be discussed with reference to FIG. 4D, the target DFA graph includes a plurality of nodes and associated transition arcs indicating logical paths from a starting node to match node(s) and not-match node(s). Therefore, the DFA engine 126 is configured to traverse the transition arcs encoded in the object file 128 based upon a value of the payload 122.

Additionally, the DFA engine 126 can be configured to output a bitmask 130 to indicate, for example, with a logical ‘1’ which of the payloads 122 satisfy the numerical condition 116, in some examples. This can help to reduce a size of the result buffer 124 compared to utilizing pointers to the payloads 122 that satisfy the numerical condition 116. As a specific example, the payload 122 can be split into logical records, for example in rows, and the bits of the bitmask 130 can represent whether or not an individual logical record satisfies the predicate 112. Such a configuration helps to enable relatively less data sent over the network 102 as the relevant data 114. In other examples, the result buffer 124 may have another suitable configuration. In various examples, the regex hardware accelerator 120 can be implemented using one or more of Application Specific Integrated Circuits (ASICs), Field Programmable Gate Arrays (FPGAs), Erasable and/or Complex programmable logic devices (PLDs), Programmable Array Logic (PAL) devices, or Generic Array Logic (GAL) devices.

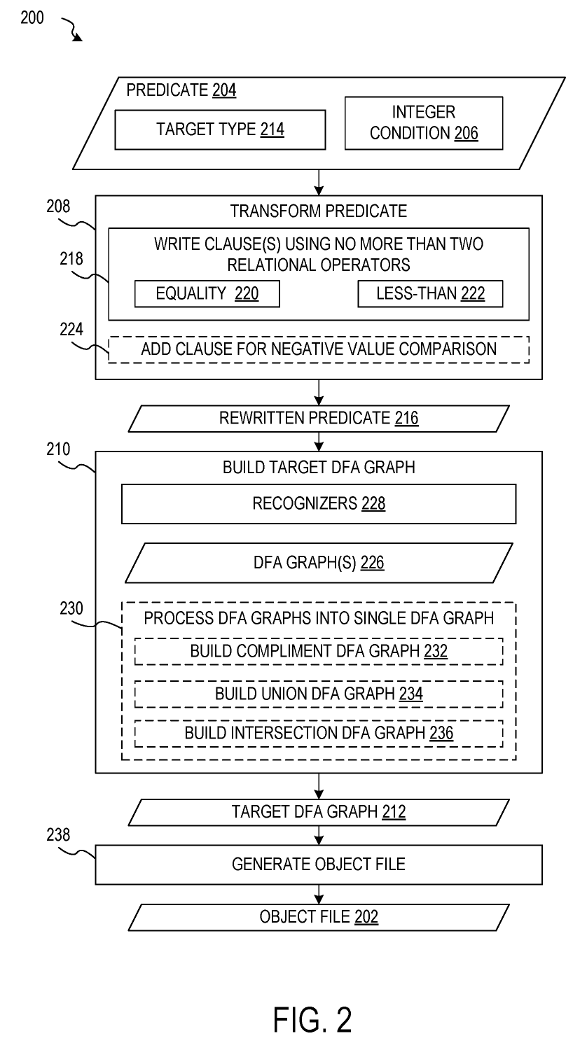

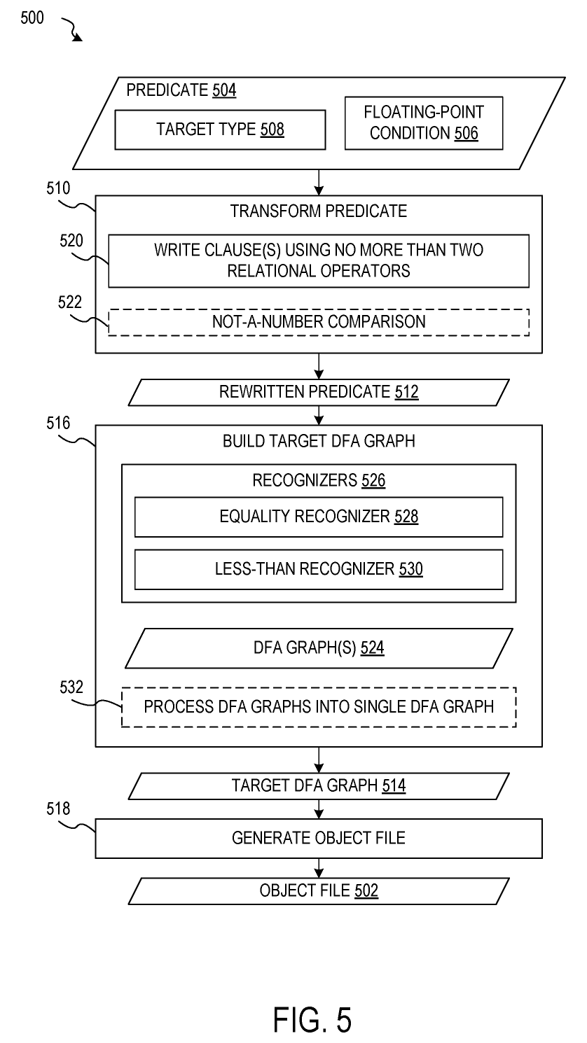

A compiler 132 is included in the DPU 118 for generating the object file 128. Subsequently, at least a portion of the object file 128 is loaded into corresponding one or more caches 134 coupled to the one or more DFA engines 126. The object file 128 can include a binary file or another suitable file format. Briefly, the compiler 132 is executable to transform the predicate 112 to form a rewritten predicate, and to build the target DFA graph based at least upon the rewritten predicate. The compiler 132 is further executable to generate the object file 128 based at least upon the target DFA graph. Here, the target DFA graph is a single DFA graph with at least one range slot. As used herein, a range slot refers to a single transition arc that captures a range of values. In some examples, the target DFA graph can optionally include a fall-through slot in which a transition from one node to another node in the target DFA graph does not consume a byte of the payload 122. Such a target DFA graph can help to reduce a size of the object file 128 over traditional DFA graphs and thus, may consume relatively less of a single cache 134. As such, this reduced size enables more of the object file 128 to be loaded into the cache 134 and thereby helping to relatively increase a cache hit-rate and performance of the regex hardware accelerator 120. Such a configuration enables the compiler 132 to encode rules for a numerical condition in a custom DFA which may result in the DFA engine 126 filtering the payloads 122 faster than a NFA engine or a general CPU. Further aspects of the compiler 132 are discussed with reference to FIGS. 2 and 5. In various examples, the compiler 132 can be implemented in software, firmware, hardware, or suitable combinations thereof.

In such a manner, the combination of the compiler 132 and the DFA engines 126 enables predicate pushdown for predicates including a numerical condition. Further, the DFA engines 126 may process the predicates faster than NFA engines thereby reducing runtime of the query processing. Additionally by filtering the payloads 122 to aggregate the relevant data 114, the regex hardware accelerator 120 helps to relatively reduce data transmitted over the network 102 which may result in a relatively increased query processing performance compared to not utilizing predicate pushdown. FIG. 1 is illustrative. In other examples, the computing system 100 may have another configuration.

As previously mentioned, a target DFA graph is built from a predicate including a numerical condition with a comparison relative to a constant number. In some examples, the constant number can be an integer. Likewise, such a numerical condition is referred to herein as an “integer condition.” FIG. 2 illustrates a flowchart of an example method 200 for generating an object file 202 from a predicate 204 including an integer condition 206. The method 200 can be performed on suitable compilers for DFA engines, such as the compiler 132, for example. Briefly, the object file 202 is generated by transforming, at 208, the predicate 204 and building, at 210, a target DFA graph 212.

As depicted, the predicate 204 has a target type 214 associated with the integer condition 206. The target type 214 specifies various attributes for an integer in the integer condition 206. As examples of integer attributes, a size specifies a number of bytes for the integer. Additionally, the integer can be a signed type with a specified sign representation (e.g., sign-magnitude, two’s compliment, etc.) for positive and negative values. Alternatively, the integer can be an unsigned type expressing only positive values. Another example integer attribute includes a little-endian type in which less significant bits arrive in a byte stream before more significant bits of a payload. Alternatively, the integer can be a big-endian type in which the more significant bits arrive in a byte stream before the less significant bits. In other examples, the predicate 204 may include other suitable information.

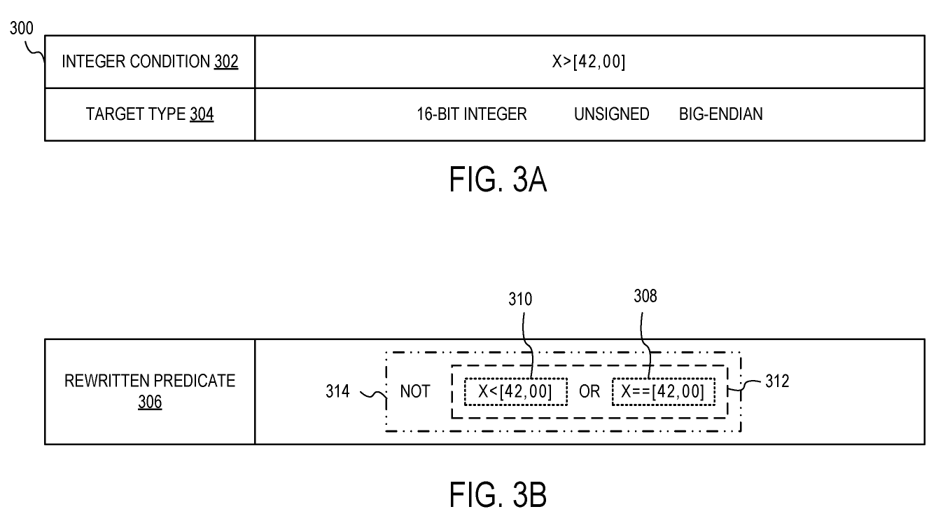

FIG. 3A schematically depicts an example predicate 300. Here, the predicate 300 includes an integer condition 302 in the form of “x>[42,00].” Thus, “[42,00]” is considered the constant integer of the predicate 300, expressed in a byte sequence with a hexadecimal value of 42 followed by a hexadecimal value of 00. Such an arrangement is specified by a target type 304 with a size of 16 bits (or 2 bytes). Further, the target type 304 specifies an unsigned type and a big-endian type. Here, the target type 304 specifies that “[42,00]” is interpreted as a decimal value of 16896. In other examples, a different target type may be used. The predicate 300 is illustrative. In other examples, another suitable integer condition and/or target type may be used.

Returning to FIG. 2, the method 200 transforms, at 208, the predicate 204 to form a rewritten predicate 216 with an equivalent expression to the predicate 204. Here, transforming the predicate 204 comprises, at 218, writing one or more clauses in the rewritten predicate 216 using no more than two relational operators. The relational operators are selected from an equality operator, a greater-than operator, and a less-than operator. In the depicted example, the relational operators selected are an equality operator 220 and a less-than operator 222. In other examples, other suitable combinations of the relational operators may be selected. Further, a logical operator may be associated with one or more clauses such that the rewritten predicate 216 has the equivalent expression. In some examples, the relevant logical operator can include a Boolean NOT-operator to negate an associated clause of the rewritten predicate 216. Additionally or alternatively, the relevant logical operator can include a Boolean AND-operator and/or a Boolean OR-operator to combine two or more associated clauses.

Transforming the predicate 204 can optionally comprise adding to the rewritten predicate 216 a clause for a negative value comparison when the target type 214 includes the signed type, as indicated at 224. This enables the rewritten predicate 216 to be in a form that matches the same bit patterns in the predicate 204 but operates in terms of an unsigned type. Such a configuration helps to relatively reduce a complexity of building the target DFA graph 212.

FIG. 3B schematically depicts an example of a rewritten predicate. More particularly, the predicate 300 of FIG. 3A is rewritten using the equality operator 220, the less-than operator 222, and relevant logical operators to form a rewritten predicate 306. As depicted, the rewritten predicate 306 includes a first clause 308 of “x==[42,0]” and a second clause 310 of “x<[42,0].” Additionally, a Boolean OR-operator is associated with the first and second clauses 308, 310, to thereby form a combined clause 312. Subsequentially, a Boolean NOT-operator negates the combined clause 312 so that the rewritten predicate 306 has an equivalent expression 314 to the predicate 300. Further, a negative value comparison is not added to the rewritten predicate 306 as the target type 304 includes the unsigned type. FIG. 3B is illustrative. In other examples, a rewritten predicate may have another configuration.

Returning to FIG. 2, the method 200 comprises building the target DFA graph 212 based at least upon the rewritten predicate 216 as indicated at 210. Specifically, building the target DFA graph 212 includes building one or more DFA graphs 226 corresponding to the one or more clauses in the rewritten predicate 216. Examples of such DFA graphs are discussed with reference to FIGS. 4A and 4B. In the depicted example, the method 200 utilizes recognizers 228 corresponding to the equality operator 220 and the less-than operator 222 to build the one or more DFA graphs 226. Further, the recognizers 228 can include a big-endian less-than recognizer and a little-endian less-than recognizer. In other examples, other suitable recognizers may be used.

Additionally, building the target DFA graph 212 can comprise processing the one or more DFA graphs 226 into a single DFA graph as indicated at 230. The single DFA graph includes at least one range slot and optionally a fall-through slot as previously discussed. Further, the target DFA graph 212 includes the single DFA graph. An example series of DFA graphs processed into a single DFA graph are discussed with reference to FIGS. 4C and 4D. In examples where a clause is associated with the Boolean NOT-operator, processing the DFA graphs includes building a compliment DFA graph from the DFA graph corresponding to the clause as indicated at 232. In some examples, processing the DFA graphs includes building a union DFA graph from the DFA graphs corresponding to two or more clauses associated with the Boolean OR-operator as indicated at 234. Alternatively or additionally, processing the DFA graphs can include building an intersection DFA graph from the DFA graphs corresponding to two or more clauses associated with the Boolean AND-operator as indicated at 236. Thus, the target DFA graph 212 is built based at least upon the rewritten predicate 216.

The method 200 also comprises, at 238, generating the object file 202 based at least upon the target DFA graph 212. The object file 202 is an example of the object file 128 and therefore, is executable by the DFA engines 126. As such, the method 200 enables the relatively faster DFA engines 126 to execute an encoding of an integer condition faster than a NFA engine. Additionally, the object file 202 enables filtering of payloads at a storage node instead of a relatively slower manner of sending payloads to a compute node for filtering. FIG. 2 is illustrative. In other examples, a target DFA graph may be built in another suitable manner.

As previously discussed, building a target DFA graph can include building DFA graphs and then processing the DFA graphs into a single DFA graph for the target DFA graph. FIGS. 4A, 4B, 4C, and 4D, schematically illustrate an example series of DFA graphs utilized in building a target DFA graph for the rewritten predicate 306 of FIG. 3B. Briefly, each DFA graph is configured to evaluate a first byte 400 and then a second byte 402 by traversing from a starting node A to a match node C or a not-match node E.

In FIG. 4A, a first DFA graph 404 corresponds to the first clause 308 of “x==[42,00].” With reference to the first byte 400, a single transition arc from the starting node A to a node B is included in the first DFA graph 404 for a value of 42. Likewise, a single transition arc from the starting node A to a node D is included for values inclusive to a range of 0 to 41 and a range of 43 to 255.

With respect to the node B, for a value of 0 for the second byte 402, a single transition arc from the node B to the match node C is included in the first DFA graph 404. Therefore, when the first byte 400 and the second byte 402 respectfully have the values of 42 and 0, the first DFA graph 404 is traversed to the match node C, thereby determining that the first clause 308 is satisfied. Alternatively, other values for the first and second bytes 400, 402, traverse to the not-match node E. As such, for a value inclusive to a range of 1 to 255 for the second byte 402, a single transition arc from the node B to the not-match node E is included in the first DFA graph 404. Another transition arc is also included from the node D to the not-match node E.

In FIG. 4B, a second DFA graph 406 corresponds to the second clause 310 of “x<[42,00]”. Here, for values of the first byte 400 that are inclusive to a range of 0 to 41, a single transition arc from the starting node A to a node B is included in the second DFA graph 406. Further, a transition arc from the node B to the match node C is included for values that are inclusive to a range of 0 to 255 for the second byte 402.

Additionally, a transition arc from the starting node A to a node D is included in the second DFA graph 406 the values that are inclusive to a range of 42 to 255 for the first byte 400. A transition arc is also included in the second DFA graph 406 from the node D to the not-match node E.

As discussed, the first clause 308 and the second clause 310 are combined to form the combined clause 312. Likewise, in FIG. 4C, a union DFA graph 408 is built from the first DFA graph 404 and the second DFA graph 406. Here, each node of the union DFA graph 408 is a composite of suitable pairs of nodes from the first and second DFA graphs 404, 406. Further, corresponding possible transitions between the composite nodes are determined. As such, the union DFA graph 408 can evaluate the first byte 400 by including a transition arc from the starting node A to a node B for values inclusive to a range of 0 to 42. Likewise, a transition arc from the starting node A to a node D is included for values inclusive to a range of 43 to 255. To evaluate the second byte 402, a transition arc from the node B to the match node C is included for a value of 0. Another transition arc is included from the node B to the not-match node E for the values inclusive to a range of 1 to 255.

In FIG. 4D, a compliment DFA graph 410 is built from the union DFA graph 408. Here, the match node C of the union DFA graph 408 is flipped to a not-match node F as indicated by 412. Likewise, the not-match node E of the union DFA graph 408 is flipped to a match node G as indicated by 414. Thus, the compliment DFA graph 410 encodes the equivalent expression 314. Further, the compliment DFA graph 410 can be used as a target DFA graph corresponding to the rewritten predicate 306. FIGS. 4A, 4B, 4C, and 4D are illustrative. In other examples, other DFA graphs may be used and/or processed to form a target DFA graph.

The above examples relate to predicates having an integer condition. In other examples, a predicate can include a numerical condition with a comparison relative to a floating-point number, referred to herein as a “floating-point condition.” Further, the floating-point number represents a real number with a signed sequence of bits, scaled by an integer exponent with a binary base. FIG. 5 illustrates a flowchart of an example method 500 for generating an object file 502 from a predicate 504 including a floating-point condition 506. The method 500 can be performed on suitable compilers for DFA engines, such as the compiler 132, for example.

Similar to the predicate 204, the predicate 504 has a target type 508 associated with the floating-point condition 506. Here, the target type 508 specifies a size in terms of bits along with a little-endian type or a big-endian type. Further, the target type 508 also specifies a sign representation (e.g., sign-magnitude, two’s compliment, etc.) for the signed sequence of bits. In other examples, the predicate 504 may include other suitable information.

Similar to the method 200, the method 500 comprises, at 510, transforming the predicate 504 to form a rewritten predicate 512 with an equivalent expression to the predicate 504. Additionally, the method 500 comprises building a target DFA graph 514 based at least upon the rewritten predicate 512 as indicated at 516. Further, the method 500 comprises, at 518, generating the object file 502 based at least upon the target DFA graph 514. The object file 502 is an example of the object file 128 and therefore, is executable by the DFA engines 126.

In a likewise manner to the method 200, transforming the predicate 504 comprises writing one or more clauses in the rewritten predicate 512 using no more than two relational operators as indicated at 520. In some examples, a logical operator may be associated with one or more clauses such that the rewritten predicate 512 has the equivalent expression. In the current example, transforming the predicate 504 can optionally include adding a clause for a not-a-number comparison as indicated at 522. Such a configuration helps to address the special case of when a value of the floating-point number is not-a-number.

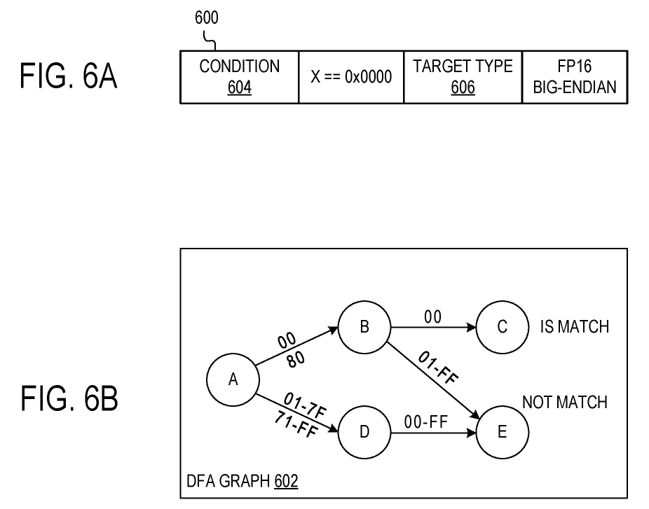

Building the target DFA graph 514 includes building one or more DFA graphs 524 corresponding to the one or more clauses in the rewritten predicate 512 in a similar manner as discussed with reference to FIG. 2. Further, the method 500 can utilize recognizers 526 corresponding to the relational operators selected at 520 to build the DFA graphs 524. In the current example, an equality recognizer 528 can be configured in a similar manner as the integer equality recognizer of FIG. 2. However, a value of +0.0 and a value of -0.0 for the floating-point number can be considered equivalent in some examples. As such, the equality recognizer 528 can be further configured to build a DFA graph where the values of +0.0 and -0.0 are considered equivalent as discussed with reference to FIGS. 6A and 6B. In other examples, the values of +0.0 and -0.0 may not be considered equivalent.

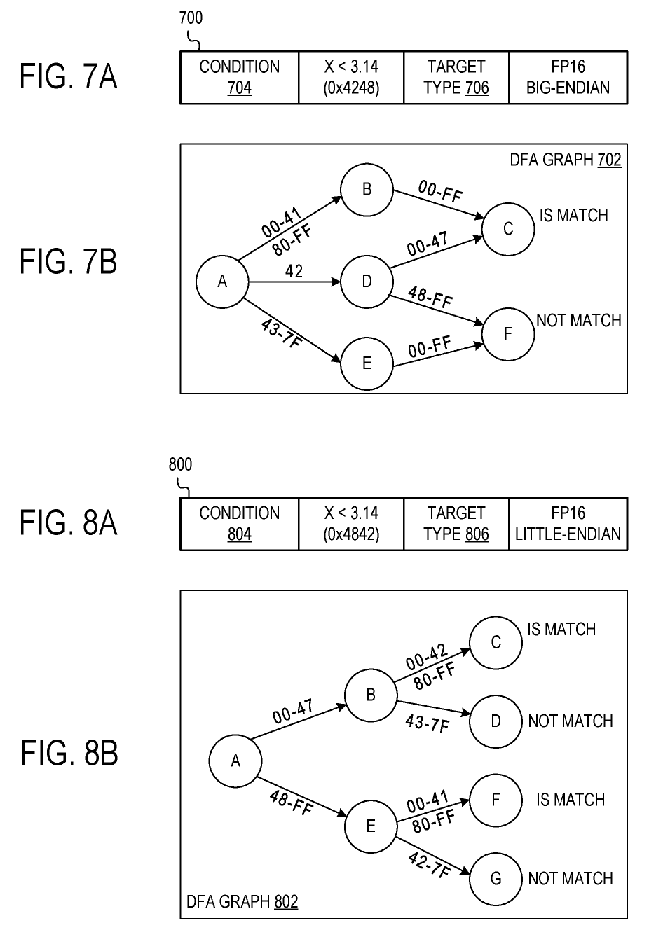

The recognizers 526 include a less-than recognizer 530. Here, the less-than recognizer 530 is configured to interpret the floating-point number as an integer with a sign-magnitude representation. Therefore, the less-than recognizer 530 addresses the most significant bit of the floating-point number as a sign bit, and a remainder of the bits as an unsigned absolute-value in the form of an integer. This enables the less-than recognizer 530 to build a DFA graph for the unsigned absolute-value in a similar manner as the integer less-than recognizer of FIG. 2. Additionally, the less-than recognizer 530 can adjust suitable transition arc(s) for a negative value comparison based at least upon the sign bit. In some examples, the less-than recognizer 530 can have a little-endian version and a big-endian version. Examples of predicates and corresponding DFA graphs that utilize the less-than recognizer 530 are discussed with reference to FIGS. 7A, 7B, 8A, and 8B . In other examples, other suitable recognizers may be used.

Building the target DFA graph 514 can additionally comprise processing the DFA graph(s) 524 into a single DFA graph as indicated at 532. Processing the DFA graph(s) 524 can be performed in suitable manners similar to those discussed with reference to FIG. 2. Likewise, the single DFA graph includes at least one range slot and optionally a fall-through slot. Further, the target DFA graph 514 includes the single DFA graph. As such, the method 500 enables the relatively faster DFA engines 126 to execute an encoding of a floating-point condition faster than a NFA engine. Additionally, the object file 202 enables filtering of payloads at a storage node instead of a relatively slower manner of sending payloads to a compute node for filtering. FIG. 5 is illustrative. In other examples, a target DFA graph may be built in another suitable manner for a predicate having a floating-point condition.

As previously mentioned, the equality recognizer 528 can be configured to build a DFA graph where the values of +0.0 and -0.0 are considered equivalent. FIGS. 6A and 6B schematically depict an example predicate 600 with a comparison to such values and a corresponding DFA graph 602, respectively. In FIG. 6A, the predicate 600 has a floating-point condition 604 of “X==0x0000.” Further, a target type 606 specifies a size of 16 bits (“FP16”) and the big-endian type. In FIG. 6B, the DFA graph 602 is built such that both a value of 0x0000 and 0x8000 satisfy the floating-point condition 604. As can be seen, the DFA graph 602 has a substantially similarly structure to the first DFA graph 404 of FIG. 4A. Here, a transition arc from a starting node A to a node B for values of 00 and 80, and a transition arc from the node B to a match node C for a value of 00 are included in the DFA graph 602. Additional transition arcs to a node D and to a not-match node E for other values are also included in the DFA graph 602. FIGS. 6A and 6B are illustrative. In other examples, another DFA graph may be used.

The above example illustrates a DFA graph built using the equality recognizer 528. In other examples, the less-than recognizer 530 may be used. FIGS. 7A and 7B schematically depict an example predicate 700 and a corresponding DFA graph 702 utilizing the less-than operator, respectfully. In FIG. 7A, the predicate 700 has a floating-point condition 704 of “X<3.14.” Here, a target type 706 specifies a size of 16 bits and the big-endian type so that 3.14 has the form of 0x4248. In FIG. 7B, the DFA graph 702 comprises a starting node A, a match node C, and a not-match node F. A transition arc from the starting node A for values less than 42 (00-41) and negative values (80-FF) to a node B is included in the DFA graph 702. Further, a transition arc from the starting node A to a node D for a value of 42 is also included in the DFA graph 702. Additionally, for values greater than 42 (43-FF) a transition arc from the starting node A to a node E is included in the DFA graph 702.

With respect to the node D, a transition arc to the match node C for values less than 48 (00-47) is included in the DFA graph 702. Also, a transition arc to the not-match node F for values greater than or equal to 48 (48-FF) is included. Additional transition arcs are included from the node B to the match node C and from the node E to the not-match node F for other values. FIGS. 7A and 7B are illustrative. In other examples, another DFA graph may be used.

Alternatively, a floating-point condition may have an associated target type that includes the little-endian type. FIGS. 8A and 8B schematically depict such an example predicate 800 and corresponding DFA graph 802, respectfully. In FIG. 8A, a floating-point condition 804 is in the form of “X<3.14.” Here, the target type 806 includes the little-endian type and therefore specifies that 3.14 is in the form of 0x4842.

In FIG. 8B, the DFA graph 802 includes a starting node A, match nodes C and F, and not-match nodes D and G. The DFA graph 802 has a transition arc from the starting node A to a node B for values that are less than 48. From the node B, the DFA graph 802 has a transition arc to the match node C for values that are less than 43 including negative values (00-42 and 80-FF). Additionally, the DFA graph 802 has a transition arc to the not-match node D from the node B for values greater than or equal to 43 (43-7F).

The DFA graph 802 has another transition arc from the starting node A to a node E for values greater than or equal to 48. Additionally, from the node E, the DFA graph 802 includes a transition arc for values that are less than 42 including negative values (00-41 and 80-FF). Another transition arc is included from the node E for values greater than or equal to 42 (42-7F). FIGS. 8A and 8B are illustrative. In other examples, another DFA graph may be used.

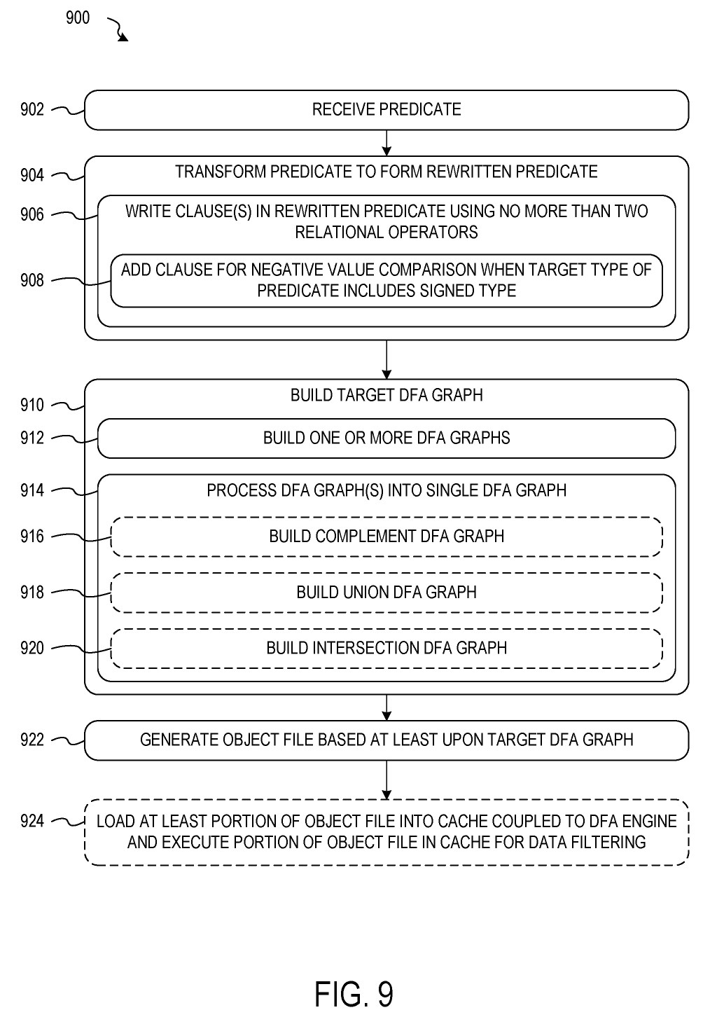

FIG. 9 illustrates a flowchart of an example method 900 for generating target DFA graphs utilizing integer and/or floating-point conditions. The method 900 can be performed on suitable computing devices that include one or more DFA engines, such as the DPU 118, for example. The method 900 comprises, at 902, receiving a predicate including one or more of an integer condition or a floating-point condition. For example, the predicates 204, 300, 504, 600, 700, or 800 may be used.

At 904, the method 900 comprises transforming the predicate to form a rewritten predicate with an equivalent expression. In some examples, transforming the predicate to form the rewritten predicate can comprise writing one or more clauses in the rewritten predicate using no more than two relational operators, as indicated at 906. The relational operators are selected from an equality operator, a less-than operator, and a greater-than operator. In some such examples, one or more logical operators may be associated with one or more clauses such that the rewritten predicate has the equivalent expression. Alternatively or additionally, transforming the predicate to form the rewritten predicate can comprise adding a clause for a negative value comparison when a target type of the predicate includes a signed type, as indicated at 908.

The method 900 further comprises, at 910, building a target DFA graph based at least upon the rewritten predicate. In some examples, building the target DFA graph comprises building one or more DFA graphs corresponding to the one or more clauses in the rewritten predicate, as indicated at 912. For example, the first DFA graph 404 and the second DFA graph 406 may be used. In some such examples, building the target DFA graph comprises processing the one or more DFA graphs into a single DFA graph with at least one range slot, as indicated at 914. In such examples, the target DFA graph comprises the single DFA graph.

Processing the one or more DFA graphs can optionally comprise building a compliment DFA graph from the DFA graph corresponding to a clause associated with a Boolean NOT-operator, as indicated at 916. Alternatively or additionally, processing the one or more DFA graphs can comprise building a union DFA graph from the DFA graphs corresponding to two or more clauses associated with a Boolean OR-operator, as indicated at 918. Likewise, processing the one or more DFA graphs can comprise building an intersection DFA graph from the DFA graphs corresponding to two or more clauses associated with a Boolean AND-operator, as indicated at 920. In further examples, one or more combined clauses may alternatively or additionally be used for 916, 918, and 920.

The method 900 comprises, at 922, generating an object file based at least upon the target DFA graph. The object file is executable by suitable DFA engines, such as the DFA engines 126, for example. The method 900 optionally comprises loading at least a portion of the object file into a cache coupled to the DFA engine and executing, using the DFA engine, the portion of the object file in the cache for data filtering, as indicated at 924. Therefore, the method 900 helps to enable predicate pushdown utilizing numerical conditions to a storage node. Additionally, the method 900 enables relatively faster DFA engines to execute an encoding of a numerical condition in less time than an NFA engine. This helps to relatively increase a query processing performance when evaluating the numerical conditions.

In some embodiments, the methods and processes described herein may be tied to a computing system of one or more computing devices. In particular, such methods and processes may be implemented as a computer-application program or service, an application-programming interface (API), a library, and/or other computer-program product.

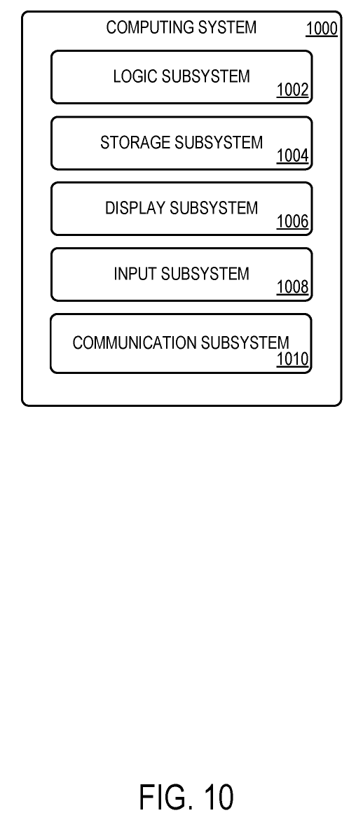

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), and/or other computing devices. The computing system 100 is an example of computing system 1000.

Computing system 1000 includes a logic subsystem 1002 and a storage subsystem 1004. Computing system 1000 may optionally include a display subsystem 1006, input subsystem 1008, communication subsystem 1010, and/or other components not shown in FIG. 10.

Logic subsystem 1002 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result. The compute nodes 104 and the storage nodes 106 are examples of the logic subsystem 1002.

The logic subsystem may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage subsystem 1004 includes one or more physical devices configured to hold instructions executable by the logic machine to implement the methods and processes described herein. When such methods and processes are implemented, the state of storage subsystem 1004 may be transformed—e.g., to hold different data. The storage disks 108 is an example of the storage subsystem 1004.

Storage subsystem 1004 may include removable and/or built-in devices. Storage subsystem 1004 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1004 may include volatile, nonvolatile, dynamic, static, read/write, read-only, random-access, sequential-access, location-addressable, file-addressable, and/or content-addressable devices.

It will be appreciated that storage subsystem 1004 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 1002 and storage subsystem 1004 may be integrated together into one or more hardware-logic components. Such hardware-logic components may include field-programmable gate arrays (FPGAs), program- and application-specific integrated circuits (PASIC / ASICs), program- and application-specific standard products (PSSP / ASSPs), system-on-a-chip (SOC), and complex programmable logic devices (CPLDs), for example.

The terms “module,” “program,” and “engine” may be used to describe an aspect of computing system 1000 implemented to perform a particular function. In some cases, a module, program, or engine may be instantiated via logic subsystem 1002 executing instructions held by storage subsystem 1004. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices. The analytics application 110 is an example of a service.

When included, display subsystem 1006 may be used to present a visual representation of data held by storage subsystem 1004. This visual representation may take the form of a graphical user interface (GUI). As the herein described methods and processes change the data held by the storage machine, and thus transform the state of the storage machine, the state of display subsystem 1006 may likewise be transformed to visually represent changes in the underlying data. Display subsystem 1006 may include one or more display devices utilizing virtually any type of technology. Such display devices may be combined with logic subsystem 1002 and/or storage subsystem 1004 in a shared enclosure, or such display devices may be peripheral display devices.

When included, input subsystem 1008 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1010 may be configured to communicatively couple computing system 1000 with one or more other computing devices. Communication subsystem 1010 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

One example provides a computing device comprising a regular expression (regex) hardware accelerator including a deterministic finite automaton (DFA) engine configured to execute an object file. The computing device further comprises a compiler executable to generate the object file based at least upon a target DFA graph by receiving a predicate including one or more of an integer condition or a floating-point condition, transforming the predicate to form a rewritten predicate with an equivalent expression, and building the target DFA graph based at least upon the rewritten predicate. In some such examples, the compiler alternatively or additionally is executable to transform the predicate to form the rewritten predicate by writing one or more clauses in the rewritten predicate using no more than two relational operators, the relational operators selected from an equality operator, a less-than operator, and a greater-than operator. In some such examples, the compiler alternatively or additionally is executable to transform the predicate to form the rewritten predicate further by adding to the rewritten predicate a clause for a negative value comparison when a target type of the predicate includes a signed type. In some such examples, the compiler alternatively or additionally is executable to build the target DFA graph by building one or more DFA graphs corresponding to the one or more clauses in the rewritten predicate. In some such examples, the compiler alternatively or additionally is executable to build the target DFA graph by processing the one or more DFA graphs into a single DFA graph with at least one range slot, and wherein the target DFA graph comprises the single DFA graph. In some such examples, processing the one or more DFA graphs alternatively or additionally comprises one or more of building a compliment DFA graph from the DFA graph corresponding to a clause associated with a Boolean NOT-operator, building a union DFA graph from the DFA graphs corresponding to two or more clauses associated with a Boolean OR-operator, or building an intersection DFA graph from the DFA graphs corresponding to two or more clauses associated with a Boolean AND-operator. In some such examples, the regex hardware accelerator alternatively or additionally includes a cache coupled to the DFA engine, the cache configured to load at least a portion of the object file.

Another example provides a computing device comprising a regular expression (regex) hardware accelerator including a deterministic finite automaton (DFA) engine configured to execute an object file, and a cache coupled to the DFA engine, the cache configured to load at least a portion of the object file. The computing device further comprises a compiler executable to generate the object file based at least upon a target DFA graph by receiving a predicate including one or more of an integer condition or a floating-point condition, transforming the predicate to form a rewritten predicate with an equivalent expression, and building the target DFA graph based at least upon the rewritten predicate. In some such examples, the compiler alternatively or additionally is executable to transform the predicate to form the rewritten predicate by writing one or more clauses in the rewritten predicate using no more than two relational operators, the relational operators selected from an equality operator, a less-than operator, and a greater-than operator. In some such examples, the compiler alternatively or additionally is executable to transform the predicate to form the rewritten predicate further by adding to the rewritten predicate a clause for a negative value comparison when a target type of the predicate includes a signed type. In some such examples, the compiler alternatively or additionally is executable to build the target DFA graph by building one or more DFA graphs corresponding to the one or more clauses in the rewritten predicate. In some such examples, the compiler alternatively or additionally is executable to build the target DFA graph by processing the one or more DFA graphs into a single DFA graph with at least one range slot, and wherein the target DFA graph comprises the single DFA graph. In some such examples, processing the one or more DFA graphs alternatively or additionally comprises one or more of building a compliment DFA graph from the DFA graph corresponding to a clause associated with a Boolean NOT-operator, building a union DFA graph from the DFA graphs corresponding to two or more clauses associated with a Boolean OR-operator, or building an intersection DFA graph from the DFA graphs corresponding to two or more clauses associated with a Boolean AND-operator.

Another example provides a method on a computing device including a deterministic finite automaton (DFA) engine configured to execute an object file. The method comprises receiving a predicate including one or more of an integer condition or a floating-point condition, transforming the predicate to form a rewritten predicate with an equivalent expression, building a target DFA graph based at least upon the rewritten predicate, and generating the object file based at least upon the target DFA graph. In some such examples, transforming the predicate to form the rewritten predicate alternatively or additionally comprises writing one or more clauses in the rewritten predicate using no more than two relational operators, the relational operators selected from an equality operator, a less-than operator, and a greater-than operator. In some such examples, transforming the predicate to form the rewritten predicate alternatively or additionally comprises adding to the rewritten predicate a clause for a negative value comparison when a target type of the predicate includes a signed type. In some such examples, building the target DFA graph alternatively or additionally comprises building one or more DFA graphs corresponding to the one or more clauses in the rewritten predicate. In some such examples, building the target DFA graph alternatively or additionally comprises processing the one or more DFA graphs into a single DFA graph with at least one range slot, and the target DFA graph alternatively or additionally comprises the single DFA graph. In some such examples, processing the one or more DFA graphs alternatively or additionally comprises one or more of building a compliment DFA graph from the DFA graph corresponding to a clause associated with a Boolean NOT-operator, building a union DFA graph from the DFA graphs corresponding to two or more clauses associated with a Boolean OR-operator, or building an intersection DFA graph from the DFA graphs corresponding to two or more clauses associated with a Boolean AND-operator. In some such examples, the method alternatively or additionally comprises loading at least a portion of the object file into a cache coupled to the DFA engine and executing, using the DFA engine, the portion of the object file in the cache for data filtering.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
a regular expression (regex) hardware accelerator including a deterministic finite automaton (DFA) engine configured to execute an object file; and
a compiler executable to generate the object file based at least upon a target DFA graph by
receiving a predicate including one or more of an integer condition or a floating-point condition,
transforming the predicate to form a rewritten predicate with an equivalent expression, and
building the target DFA graph based at least upon the rewritten predicate.

2. The computing device of claim 1, wherein the compiler is executable to transform the predicate to form the rewritten predicate by writing one or more clauses in the rewritten predicate using no more than two relational operators, the relational operators selected from an equality operator, a less-than operator, and a greater-than operator.

3. The computing device of claim 2, wherein the compiler is executable to transform the predicate to form the rewritten predicate further by adding to the rewritten predicate a clause for a negative value comparison when a target type of the predicate includes a signed type.

4. The computing device of claim 2, wherein the compiler is executable to build the target DFA graph by building one or more DFA graphs corresponding to the one or more clauses in the rewritten predicate.

5. The computing device of claim 4, wherein the compiler is executable to build the target DFA graph by processing the one or more DFA graphs into a single DFA graph with at least one range slot, and wherein the target DFA graph comprises the single DFA graph.

6. The computing device of claim 5, wherein processing the one or more DFA graphs comprises one or more of
building a compliment DFA graph from the DFA graph corresponding to a clause associated with a Boolean NOT-operator,
building a union DFA graph from the DFA graphs corresponding to two or more clauses associated with a Boolean OR-operator, or
building an intersection DFA graph from the DFA graphs corresponding to two or more clauses associated with a Boolean AND-operator.

7. The computing device of claim 1, wherein the regex hardware accelerator further includes a cache coupled to the DFA engine, the cache configured to load at least a portion of the object file.

8. A computing device, comprising:
a regular expression (regex) hardware accelerator including
a deterministic finite automaton (DFA) engine configured to execute an object file, and
a cache coupled to the DFA engine, the cache configured to load at least a portion of the object file; and
a compiler executable to generate the object file based at least upon a target DFA graph by
receiving a predicate including one or more of an integer condition or a floating-point condition,
transforming the predicate to form a rewritten predicate with an equivalent expression, and
building the target DFA graph based at least upon the rewritten predicate.

9. The computing device of claim 8, wherein the compiler is executable to transform the predicate to form the rewritten predicate by writing one or more clauses in the rewritten predicate using no more than two relational operators, the relational operators selected from an equality operator, a less-than operator, and a greater-than operator.

10. The computing device of claim 9, wherein the compiler is executable to transform the predicate to form the rewritten predicate further by adding to the rewritten predicate a clause for a negative value comparison when a target type of the predicate includes a signed type.

11. The computing device of claim 9, wherein the compiler is executable to build the target DFA graph by building one or more DFA graphs corresponding to the one or more clauses in the rewritten predicate.

12. The computing device of claim 11, wherein the compiler is executable to build the target DFA graph by processing the one or more DFA graphs into a single DFA graph with at least one range slot, and wherein the target DFA graph comprises the single DFA graph.

13. The computing device of claim 12, wherein processing the one or more DFA graphs comprises one or more of
building a compliment DFA graph from the DFA graph corresponding to a clause associated with a Boolean NOT-operator,
building a union DFA graph from the DFA graphs corresponding to two or more clauses associated with a Boolean OR-operator, or
building an intersection DFA graph from the DFA graphs corresponding to two or more clauses associated with a Boolean AND-operator.

14. A method on a computing device including a deterministic finite automaton (DFA) engine configured to execute an object file, the method comprising:
receiving a predicate including one or more of an integer condition or a floating-point condition;
transforming the predicate to form a rewritten predicate with an equivalent expression;
building a target DFA graph based at least upon the rewritten predicate; and
generating the object file based at least upon the target DFA graph.

15. The method of claim 14, wherein transforming the predicate to form the rewritten predicate comprises writing one or more clauses in the rewritten predicate using no more than two relational operators, the relational operators selected from an equality operator, a less-than operator, and a greater-than operator.

16. The method of claim 15, wherein transforming the predicate to form the rewritten predicate further comprises adding to the rewritten predicate a clause for a negative value comparison when a target type of the predicate includes a signed type.

17. The method of claim 15, wherein building the target DFA graph comprises building one or more DFA graphs corresponding to the one or more clauses in the rewritten predicate.

18. The method of claim 17, wherein building the target DFA graph comprises processing the one or more DFA graphs into a single DFA graph with at least one range slot, and wherein the target DFA graph comprises the single DFA graph.

19. The method of claim 18, wherein processing the one or more DFA graphs comprises one or more of
building a compliment DFA graph from the DFA graph corresponding to a clause associated with a Boolean NOT-operator,
building a union DFA graph from the DFA graphs corresponding to two or more clauses associated with a Boolean OR-operator, or
building an intersection DFA graph from the DFA graphs corresponding to two or more clauses associated with a Boolean AND-operator.

20. The method of claim 14, further comprising loading at least a portion of the object file into a cache coupled to the DFA engine and executing, using the DFA engine, the portion of the object file in the cache for data filtering.
